(19) United States
(12) Patent Application Publication
(10) Pub. No.: US 2012/0086960 A1
(43) Pub. Date: Apr. 12, 2012

(54) COLOR MATERIAL AMOUNT CONTROL METHOD AND IMAGE FORMING APPARATUS FOR LIMITING AN AMOUNT OF THE COLOR MATERIAL TO BE USED FOR IMAGE FORMATION

(75) Inventor: Toru KAWABE, Tokyo (JP)

(73) Assignee: KONICA MINOLTA BUSINESS TECHNOLOGIES, INC., Tokyo (JP)

(21) Appl. No.: 13/246,130

(22) Filed: Sep. 27, 2011

(30) Foreign Application Priority Data
Oct. 8, 2010 (JP) 2010-228440

(51) Int. Cl. H04N 1/60

(52) U.S. Cl. 358/1.9

(57) ABSTRACT

A color material amount control method having the steps of: setting a weighting factor of each color material to be used for image formation; and for each pixel, obtaining a color material amount summation by product sum of color material amount and the weighting factor of each color material, obtaining a required reduction amount for the color material amount summation from a predetermined target limit value with respect to the color material amount summation, and correcting the color material amount for each color material so as to reduce the required reduction amount from the color material amount summation.

### CROSS REFERENCE TO RELATED APPLICATION

The present application is based on Japanese Patent Application No. 2010-228440 filed with Japanese Patent Office on Oct. 8, 2010, the entire content of which is hereby incorporated by reference.

### BACKGROUND OF THE INVENTION

1. Technical Field

The present invention relates to a color material amount control method and an image forming apparatus for limiting an amount of the color material amount to be used for image formation.

2. Background Technology

In cases where the amount of color material to be used for the image formation exceeds a certain amount in addition to generating various kinds of adverse effects in the image formation according to process conditions, conveyance of a recording sheet may be troubled. For example, in an electrophotographic process, in cases where the amount per pixel of toner as the color material is too much, failure fixing is caused and the toner may scatter. While in the case of inkjet printer, a paper sheet cannot contain the excessive ink, which may cause a blurred image.

Meanwhile, there have been technologies to limit the amount of each color material in cases where a sum amount of each color material exceeds a predetermined upper limit. For example, in JP No. 2005-35012A a method is proposed which, in cases where sum of each color material amount exceeds a prescribed value, determines whether the color tone will be changed or not in case of equally decreasing the amount of each color material, and unevenly decreases the color material amount so as not to change the color tone. Further, another method is proposed in JP No. 2009-303006A. Since in case of not limiting the sum amount of color material until reaching to a sum amount limitation value and suddenly limiting the color material amount at the sum amount limitation value, color change tends to be generated at the border of with and without limitation, in order to prevent the color change, the method gradually restricts the color material amount in a prescribed range around the sum amount limitation value.

3. Problem to be Solved by the Invention

In cases where the color material amount is limited, restriction of color continuity is caused by restriction of color reproduction region or by reduction in number of reproducible colors, which will be the reason for degrading the image quality. Therefore, from the point of color reproduction, limitation of color material amount is not wanted as far as possible.

For example, in the electrophotographic process where C (Cyan), M (Magenta), Y (Yellow), and K (Black) toners are used as the color materials, when a maximum use amount of color material per one color is assumed to be 100%, control for limiting the sum amount to approximately 250% is generally conducted. FIG. 9a shows the condition of toner scattering generation in the case of sum amount of C, M, Y, K toners being 400%, and FIG. 9b shows the condition where the toner scattering is prevented by limiting the sum amount not more than 250%. Although the toner scattering can be suppressed by limiting the sum amount of toner in this way, reproducibility of the shadow area is remarkably deteriorated comparing to the case of 400% usable.

FIGS. 10-12 show color gamut of the case of 400% usable in contrast with the case of limiting to 250%. FIG. 10 shows various planes of hue directions (angles) in L*a*b* color space. FIGS. 11a-11c show actual measured example of color reproducibility in various hue angles (FIG. 11a, hue angle h=90°; FIG. 11b, hue angle h=120°; FIG. 11c, hue angle h=150°). FIG. 12 is a characteristic diagram, showing the color reproduction range in one hue angle plane, obtained from the data of FIGS. 11a-11c. In contrast to the reproducible color gamut being the range above a border line A in the case of not limiting the toner amount, the color gamut in the case of limiting the toner amount to 250% is restricted to the upper region than the border line B. The shaded area of the diagram indicates the color gamut that becomes irreproducible by limiting the toner amount. In case of limiting the toner amount, color reproducibility particularly in the shadow area (area encircled by dotted line C) is significantly reduced.

Even in the case where sum amount of YMCK color material is less than the limiting value, if sum amount of specific two colors exceeds a certain value, image quality deterioration will be possibly caused. For example, in the case of electrophotographic process, at undesirable conditions (such as at second side print of double sides printing in low temperature and low humidity ambient conditions), heat capacity for fixing becomes insufficient to cause toner scattering at a character image expressed by two color toners such as a red colored character (M 100%+Y 100%).

In order to prevent the toner scattering at the red color, it is assumed to be necessary, for example, to limit the color material amount of M+Y not more than 150%. In this case, according to the conventional method, that limits the sum amount of CMYK color material, the toner scattering at the red color character cannot be prevented unless the limiting value of the sum amount is set not more than 150%. However, if the limiting value of the sum amount of CMYK toner is set to be 150%, the limitation of color material amount is executed more than necessary which causes remarkable deterioration in color reproducibility.

Further, it is generally considered that in the case of image formation of color image by superimposing each color material, due to the difference of the printing order, or the difference of physical properties according to constituent of each of color materials, extent of contribution for toner scattering or blur image is different by each color material. Therefore, according to the conventional method which determines whether the limitation of color material amount is required or not based simply on the total usage amount of each color material, it is impossible to properly limit the color material amount based on the characteristic properties of each color material.

In order to solve the above mentioned problem, an object of the present invention is to provide a color material amount control method and an image forming apparatus for limiting an amount of the color material to be used for image formation, which can prevent harmful effects caused by excessive color material amount while suppressing the limitation of color material amount by taking the properties of each color material in consideration.

### SUMMARY OF THE INVENTION

To achieve at least one of the abovementioned objects: (1) A color material amount control method reflecting one aspect of the present invention includes the steps of:

setting a weighting factor of each color material to be used for image formation; and

for each pixel, obtaining a color material amount summation by product sum of color material amount and the weighting factor of each color material, obtaining a required reduction amount for the color material amount summation from a predetermined target limit value with respect to the color material amount summation, and correcting the color material amount for each color material so as to reduce the required reduction amount from the color material amount summation.

According to the above configuration, for each pixel, a color material amount summation is obtained by product sum of color material amount of each color material and the weighting factor, and a required reduction amount is obtained from a predetermined target limit value with respect to the color material amount summation. And the color material amount for each color material is corrected by increasing or decreasing the color material amount so as to reduce the required reduction amount from the color material amount summation. Namely, the color material amount of each color material is corrected by increasing or decreasing such that the product sum of the color material amount of each color material after increasing or decreasing and the weighting factor of each color material becomes the target limit value.

(2) A color material amount control method of above (1), wherein the weighting factor is set according to a prescribed value predetermined based on characteristics of an image forming apparatus to form an image using the color material, or the weighting factor is set according to image output conditions.

According to the above configuration, the weighting factor to be used is preliminary set according to the characteristics of the image forming apparatus, such as what kind of color materials are superimposed in what order to form a color mage, or image output conditions (ambient temperature and humidity, second side print of double side printing or not, and the like). For example, a plurality of types of weighting factors is preliminary prepared for each of image output conditions by taking the characteristics and image output conditions in consideration, and the weighting factor corresponding to the image output condition at the image formation is selected and used.

(3) A color material amount control method of above (1), wherein the weighting factor is determined according to a color of the pixel.

According to the above configuration, what type of weighting factor is used, in the color material amount limiting process for the pixel, is determined according to the color of the pixel.

(4) A color material amount control method of above (1), wherein the step of correcting the color material amount is executed sequentially in plural times by using different weighting factors.

According to the above configuration, for example, after executing a first color material amount limiting process with a first weighting factor, a second color material amount limiting process is executed with a second weighting factor on the image data having been executed the first process.

### BRIEF DESCRIPTION OF THE DRAWINGS

These and other objects, advantages and features of the invention will become apparent from the following description thereof taken in conjunction with the accompanying drawings in which:

FIG. 1 illustrates a block diagram showing a general configuration of the image forming apparatus which executes a color material amount limitation process according ₜo the color material control method relating to an embodiment of the present invention;

FIG. 2 illustrates a block diagram showing a functional configuration relating to the color material control method of the present invention;

FIG. 3 illustrates explanation drawing showing general process contents and configurations of a color material amount control section;

FIG. 4 illustrates characteristic drawing showing an example of input-output relation of a limit table;

FIG. 5 illustrates explanation drawing showing a first application example of color material amount limitation;

FIG. 6 illustrates explanation drawing showing an example where a third application example of color material amount limitation is executed after the color material amount limitation of the first application example (FIG. 5);

FIGS. 7a-7b illustrate explanation drawings showing an example of condition control table stored in the weighting factor setting section;

FIG. 8 illustrates flow chart showing operations of color material amount limitation by the weighting factor setting section and the color material amount control section;

FIGS. 9a-9b illustrate drawings showing toner scattered image and an image example of suppressed toner scattering by the color material amount limitation;

FIG. 10 is an explanation drawing illustrating a plane of each of various hue directions in L*a*b* color space;

FIGS. 11a-11c are drawings illustrating actual measured examples of color reproduction states in various hue directions; and

FIG. 12 is a characteristic drawing illustrating color reproduction range in the case of limiting the toner amount in contrast to the case of not limiting.

### DETAILED DESCRIPTION OF THE PREFERRED EMBODIMENT

Hereinafter, an embodiment of the present invention will be described based on the drawings.

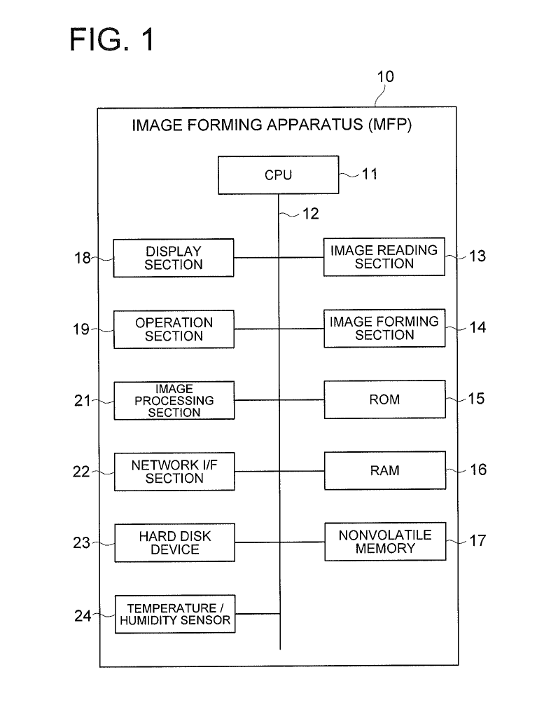

FIG. 1 illustrates a general configuration of the image forming apparatus which executes a color material amount control process according to the color material control method relating to an embodiment of the present invention. Image forming apparatus 10 is, as it is called, a color multifunction peripheral provided with a color copying function to optically read an original document and print its duplication image in color on a recording sheet, a scanning function to file and store image data of the read image and to transmit to an external terminal via a network, and a PC print function to form an image relating to a print data received via the network from the external terminal on a recording sheet to output the print.

Image forming apparatus 10 is provided with CPU (Central Processing Unit) 11 as a control section to totally control the operation of said image forming apparatus 10. Connected to CPU 11 via bus 12 are: image reading section 13, image forming section 14, ROM (Read Only Memory) 15, RAM (Random Access Memory) 16, nonvolatile memory 17, display section 18, operation section 19, image processing section 21, net work I/F section 22, hard disc device (HDD) 23, and temperature/humidity sensor 24.

In ROM 15, various programs are stored, and by the process execution of CPU 11 according to these programs, each function (including the function of executing the color material amount control method) of image forming apparatus 10 is realized. RAM 16 is utilized as a work memory to temporarily store various data in case where CPU 11 executes the program, and as an image memory to store the image data, and the like.

Image reading section 13 performs the function of optically reading out the original image to obtain the image data. Image reading section 13 is for example configured with a light source to irradiate light on the original document, a color line image sensor to receive the reflection light for reading out the original document in the width direction by one line, a moving means to sequentially move the reading position with one line unit in the longitudinal direction of the original document, a optical path composed of lens and minors to guide and focus the reflection light from the original document toward the line image sensor, a conversion section to convert the analogue image signals outputted from the line image sensor to digital image data, and the like.

Image forming section 14 performs the function of printing the color image based on the image data on the recording sheet. Here, image forming section 14 is configured as a tandem type color laser printer which utilizes C color, M color, Y color, and K color toners as the color materials for the image formation.

Image forming section 14 is provided with an endless intermediate transfer belt to be driven around. Along with this intermediate belt, arranged are an image forming section for C color, an image forming section for M color, an image forming section for Y color, and an image forming section for K color. The image forming section for C color forms C color toner image according to the C color image data and transfers on the intermediate transfer belt. The image forming section for M color forms M color toner image according to the M color image data and transfers on the intermediate transfer belt. The image forming section for Y color forms Y color toner image according to the Y color image data and transfers on the intermediate transfer belt. The image forming section for K color forms K color toner image according to the K color image data and transfers on the intermediate transfer belt. Image forming section 14 superimposes each color toner of C, M, Y, K on the intermediate transfer belt to form the full color image.

In detail, each of C, M, Y, K image forming sections is configured with a photosensitive member as a drum type electrostatic latent image carrier on whose surface the electrostatic latent image is formed, a laser unit to scan the photo sensitive member surface with a laser beam, a charging unit, a developing unit and a cleaning unit arranged around the photo sensitive member. The photosensitive member is driven to rotate in a prescribed direction with a constant rate, and the charging unit uniformly charges the photosensitive member. The laser unit scans on the photosensitive member with the laser beam modulated according to the image data to form the electrostatic latent image on the surface of the photosensitive member. The developing unit visualizes the latent image on the photosensitive member with the toner. The toner image formed on the photosensitive member is transferred onto the intermediate transfer belt at the contact point with the intermediate transfer belt. The cleaning unit scrapes the toner remained on the surface of photosensitive member after the transfer with a blade and the like to remove and collect.

The color toner image formed by each of C, M, Y, K image forming sections on the intermediate transfer belt is transferred onto the recording sheet conveyed from a sheet feeding cassette and the like at a prescribed transfer position. The toner image transferred on the recording sheet is heated and pressed to be fixed on the recording sheet at the time the recording sheet passing through the fixing unit The recording sheet after the fixing is ejected to the ejection tray in a case of single side printing. In a case of double sides printing, the recording sheet is front to back side reversed and again conveyed to the transfer position, toner image is transferred on the back side (second side) of the recording sheet from the intermediate transfer belt, and again passing through the fixing unit to be ejected in the ejection tray.

In nonvolatile memory 17, system information, user information and the like are memorized. The system information includes various data (weighting factor, etc.) for limiting the color material amount.

Display section 18 is configured with a liquid crystal display (LCD) and the like, and performs the function of displaying various operation screens, and setting screens. Operation section 19 performs the function of receiving various operations such as job setting and input operation from users. Operation section 19 is configured with a numerical key pad, character input key, start key and the like, in addition to a touch panel provided on the screen of display section 18 to detect pushed coordinate positions.

Image processing section 21 executes a rasterizing process to convert the print data to the image data, and compression and decompression process of the image data, in addition to the process of image enlargement/reduction and rotation.

Network I/F section 22 is connected to a network such as a LAN to perform functions for sending and receiving various data with a terminal apparatus and a server on the network. Hard disc device 23 is a large capacity nonvolatile memory with which is utilized for example to store the print data or image data.

Image forming apparatus relating to the present embodiment is provided with a function for limiting the usage amount of C, M, Y, K toner (color material amount limitation function). CPU 11 executes the control relating to the color material amount limitation function bases on the program stored in ROM 15. Image processing section 21 may be configured to execute a part or whole of said control.

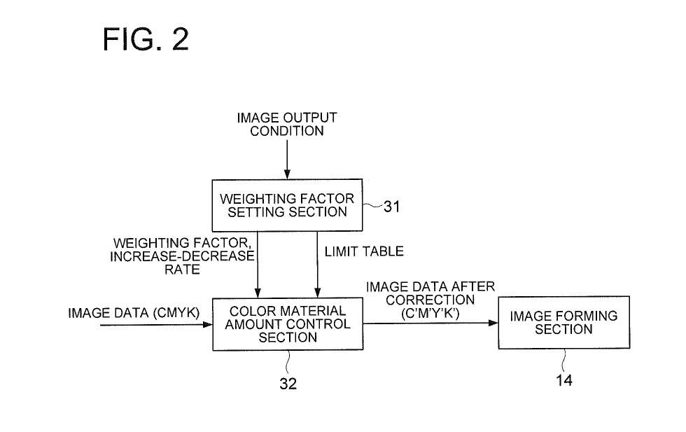

FIG. 2 illustrates a functional configuration relating to the color material amount limitation. The color material amount limitation function is realized by weighting factor setting section 31 which sets the weighting factor and increase-decrease rate for each color material (each toner of C, M, Y, K) and limit table, to be used by image forming section 14; and color material amount control section 32 which, by each pixel, limits (or controls) the color material amount to be used for printing (image forming) the pixel to restrict to an amount that does not cause a harmful effect such as the toner scattering. Image forming section 14 of image forming apparatus executes image formation based on color material amount of each color material after the limitation (or collection) by color material amount control section 32.

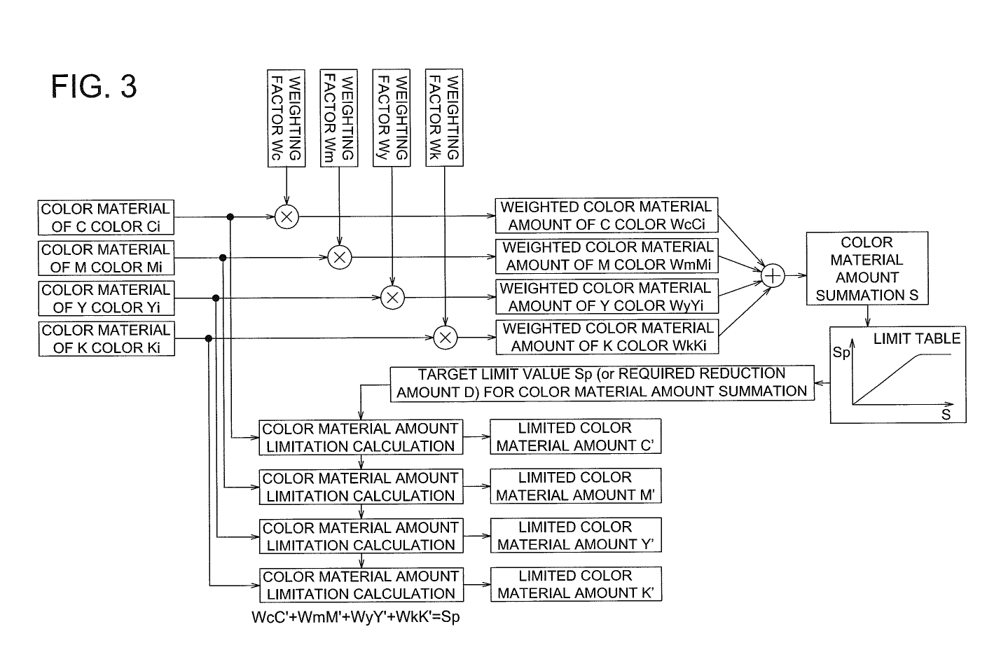

FIG. 3 shows general process contents and configurations of color material amount control section 32. The image data for each pixel (data indicating the color material amount for each color of C, M, Y, K) are inputted to color material control section 32. Further from weighting factor setting section 31, inputted are weighting factor Wc (weighting factor for C color), weighting factor Wm (weighting factor for M color), weighting factor Wy (weighting factor for Y color), and weighting factor Wk (weighting factor for K color).

Color material amount control section 32 obtains color material amount summation S by product sum of color material amount (Ci, Mi, Yi, Ki) and the weighting factor (Wc, Wm, Wy, Wk) of each color material. Namely, color material amount control section 32 obtains:

S=WcCi+WmMi+WyYi+WkKi, Wherein, color material amount summation S may be obtained based on the above calculating formula, and also may be obtained by using a reference table which, when the color material amounts Ci, Mi, Yi, Ki and the weighting factors Wc, Wm, Wy, Wk are inputted, outputs the corresponding color material amount summation S.

Color material amount control section 32 obtains target limit value Sp for the color material amount summation S, by referring to the limit table. The limit table indicates correspondence relationship (input-output relation) between color material amount summation S (input) and target limit value Sp for the color material amount summation S. The limit table is configured, for example, with a lookup table in which each value of color material amount summation S and corresponding target limit value Sp are correlated and registered. As long as target limit value Sp corresponding to color material amount summation S can be obtained, the limit table is not restricted to a table form, but may be various forms such as a function (mathematical scheme) or numerical values only indicating changing points in input-output characteristics.

Next, color material amount control section 32 executes the color material amount limitation calculation for each color material amount (Ci, Mi, Yi, Ki) based on target limit value Sp. By the color material amount limitation calculation, color material amount for each color material (Ci, Mi, Yi, Ki) is increasing/decreasing corrected based on a prescribed rule, and color material amount after correction for each color material (C′, M′, Y′, K′) is outputted. The color material amount limitation calculation, increases or decreases each color material amount based on the prescribed rule, such that the product sum (WcC′+WmM′+WyY′+WkK′) of each color material amount after correction (C′, M′, Y′, K′) and the weighting factor for each color (Wc, Wm, Wy, Wk) becomes equal to target limit value Sp.

For example the color material amount calculation is executed as described below. Firstly required reduction amount D is obtained from target limitation value Sp and color material amount summation S (reduction amount D=target limitation value Sp−color material amount summation S). Next, increasing or decreasing amount of each color material (ΔC, ΔM, ΔY, ΔK) is determined based on the prescribed rule, such that the product sum (Wc×ΔC+Wm×ΔM+Wy×ΔY+Wk×ΔK) of increasing/decreasing amount of each color material (ΔC, ΔM, ΔY, ΔK) and the weighting factor for each color (Wc, Wm, Wy, Wk) becomes equal to reduction amount D. From the determined increasing/decreasing amount of each color material, the each color material amount after correction (C′=Ci+ΔC, M′=Mi+ΔM, Y′=Yi+ΔY, K′=Ki+ΔK) are obtained.

The prescribed rule for increasing/decreasing the color material amount is preferably the one that increases or decreases each color material amount so as not to cause a color change.

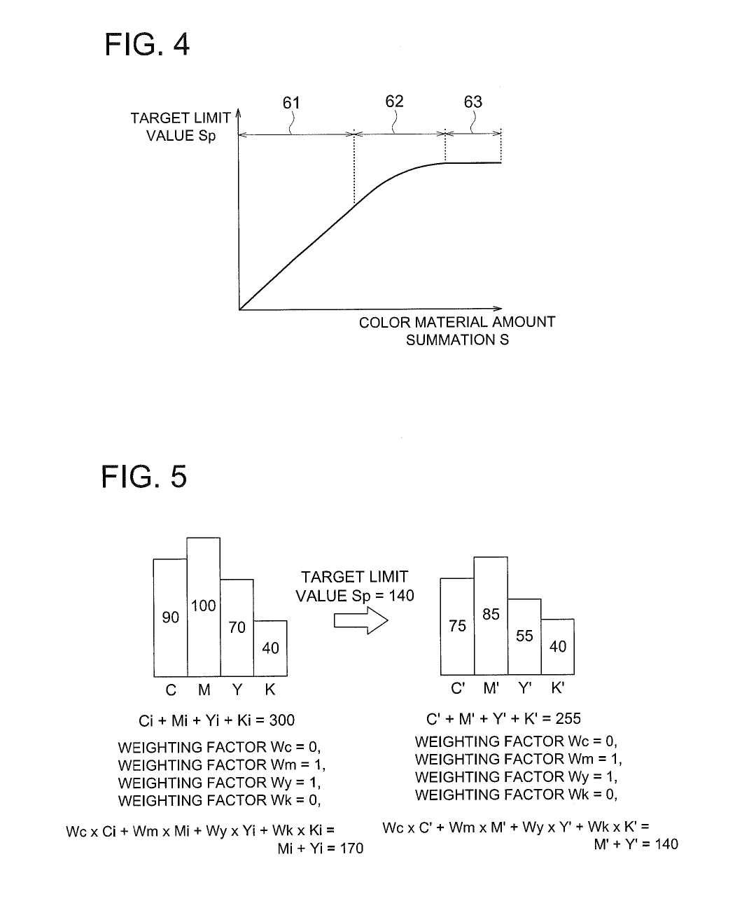

FIG. 4 shows an example of input-output relation of the limit table. Unlimited region 61 is a region where “color material amount summation S=target limit value Sp” is satisfied. Saturation region 63 is a region where the relation “target limit value Sp=fixed upper limit value” comes into effect. Transition region 62 is a region where unlimited region 61 and saturation region 63 are smoothly connected, and target limit value Sp with respect to color material amount summation S is gradually restricted.

The input-output relation of the limit table is not restricted to that shown in FIG. 4, but the one where transition region is not provided and the change from unlimited region 61 to saturation region 63 occurs at one point will do as well.

Examples of general color material amount calculation will be described below. In these examples, C, M, Y, K respectively show the value of each color material amount before the calculation, and C′, M′, Y′, K′ respectively show the calculation result value of each color material amount. Further, the limit value of color material amount is expressed as “Limit”.

### CALCULATION EXAMPLE 1

C′=(Limit−K)×C/(C+M+Y)

M′=(Limit−K)×M/(C+M+Y)

Y′=(Limit−K)×Y/(C+M+Y)

K′=K

### CALCULATION EXAMPLE 2

C′=C−offset

M′=M−offset

Y′=Y−offset

K′=K

Here, “offset” is the minimum value among (C+M+Y+K−Limit)/3, C, M, and Y.

### CALCULATION EXAMPLE 3

C′=C−min(pα, C)

M′=C−min(qα, M)

Y′=C−min(rα, Y)

K′=K+min(sα, 100−K)

Where, the upper limit value of K is assumed as 100, and p, q, r, s are respectively increase-decrease rate of each color material amount and assumed to satisfy:

−ΔC:−ΔM:−ΔY:ΔK=p:q:r:s

The above described conventional color material amount calculation is applicable to the color material amount calculation to be executed by color material amount control section 32. Namely only adjustments of the Limit and the value of α in the above calculation example 1, 2, and 3 are required in such a way that the product sum (WcC′+WmM′+WyY′+WkK′) of each color material amount (C′, M′, Y′, K′) after the correction by color material amount control section 32 and the weighting factor (Wc, Wm, Wy, Wk) becomes equal to target limit value Sp.

Weighting factor setting section 31 (FIG. 2) provides the weighting factors and the limit table previously determined according to the characteristics of image forming section 14 (FIG. 1), or the weighting factors and the limit table determined according to the image output conditions, to color material amount control section 32.

Image output conditions include types of recording sheets to be used in image forming section 14, ambient temperature and humidity, print side (whether second side of both side printing or not, etc.), print mode (such as full color or two-color mode), and the like. Types (properties) of recording sheets includes thickness of paper, smoothness of the surface and the like for the electrophotographic system using toners as color materials, and includes ink absorptive property for inkjet system.

Weighting factor setting section 31 determines the weighting factor and the limit table based on the abovementioned image output conditions, and determines whether to execute the color material amount limitation process in multiple times by switching the weighting factor and limit table.

Next, various application examples of the color material amount limitation process of the present invention will be described.

### APPLICATION EXAMPLE 1

In application example 1, total color material amount (M+Y) of color material of M color and color material Y color is limited. By setting weighting factor Wc=0, weighting factor Wm=1, weighting factor Wy=1, and weighting factor Wk=0, the limit table is created such that upper limit of color material amount summation S becomes 140%. For example, the limit table is created such that the region where input value (color material amount summation S) being up to 140 is set as unlimited region 61 (S=Sp), and in the region of input value (color material amount summation S) being over 140, the target limit value Sp=140.

Then, based on this limit table, increasing/decreasing adjustment (color material amount calculation) is executed. In the color material amount calculation, the increase-decrease rate is set such that −ΔC:−ΔM:−ΔY:ΔK=p:q:r:s, (respectively calculated from predetermined parameters or C, M, Y, K), and by the increasing or decreasing, color material amount summation S is controlled to coincide with target limit value Sp. In this regard, lower limit of color material amount of C′, M′, Y′ is restricted to 0%, and upper limit of color material amount of K′ is restricted to 100%.

To be more specific, by obtaining required reduction amount D (required reduction amount D=target limit value Sp−color material amount summation S), obtains d which satisfies: required reduction amount D=d×(Wc×p+Wm×q+Wy×r+Wk×s). And then, obtains each color material amount after the color material amount limitation, as C′=Ci+d×p, M′=Mi+d×q, Y′=Yi+d×r, K′=Ki+d×s.

According to the color material amount limitation of application example 1, toner scattering of red character image is suppressed to improve the character image quality, in the rear side print of both sides printing under low temperature/low humidity ambient conditions.

FIG. 5 shows a correction example of color material amount by the color material amount limitation of the application example 1. Color material amount of input value are Ci=90, Mi=100, Yi=70, Ki=40, and weighting factor Wc=0, weighting factor Wm=1, weighting factor Wy=1, weighting factor Wk=0. In this case, color material amount summation S becomes Mi+Yi=170. Since target limit value is 140, the required reduction amount D for color material amount summation S becomes 170−140=30. For example, in the case of equally reducing the color material amount by the abovementioned calculation example 2, since ΔM+ΔY is required to make the required reduction amount of 30, each color material amount of C, M, Y is reduced by 15. Thus, results become C′=75, M′=85, Y′=55, K′=40.

### APPLICATION EXAMPLE 2

In application example 2, execution of color material amount limitation of the application example 1 is limited only for second side print of double sides printing under low temperature and low humidity ambient conditions. This will suppress the effect of restricting color reproducibility by the color material amount limitation.

### APPLICATION EXAMPLE 3

After the execution of the application example 1 or application example 2, application example 3 is further executed. The application example 3 limits the color material amount based on the sum of CMYK, which ignores the weighting factor similarly to the conventional way. Here, the weighting factors are assumed such that: weighting factor Wc=1, weighting factor Wm=1, weighting factor Wy=1, weighting factor Wk=1, and the limit table is created such that the upper limit of color material amount summation S becomes 250%. For example, the limit table is created such that unlimited region 61 (S=Sp) is set until the input value (color material amount summation S) becomes 250, and in the region where input value (color material amount summation S) is 250 or more, the target limit value Sp=250 is set.

Then, based on this limit table, increasing/decreasing adjustment of the color material amount (color material amount calculation) is executed. In the color material amount calculation, the increase-decrease rate is set such that −ΔC:−ΔM:−ΔY:ΔK=p:q:r:s, (respective values are calculated from predetermined parameters or C, M, Y, K), and by the increasing or decreasing, color material amount summation S is controlled to coincide with target limit value Sp. In this regard, lower limit of color material amount of C, M, Y is restricted to 0%, and upper limit of color material amount of K is restricted to 100%.

The color material amount limitation of application example 3 is executed without considering the weighting factors similarly to the conventional way. Further, since the color material amount limitation of application example 3 is executed after the execution of the application example 1 or application example 2, it can cope with both the red character scattering problem and the usual fixing failure due to color material amount being over 250%. Various color material amount limitations different in the weighting factor or limit table may be executed in arbitral order. For example, after the execution of color material amount limitation of application example 3, the application example 1 or application example 2, may be executed. The result is not varied by the order of execution.

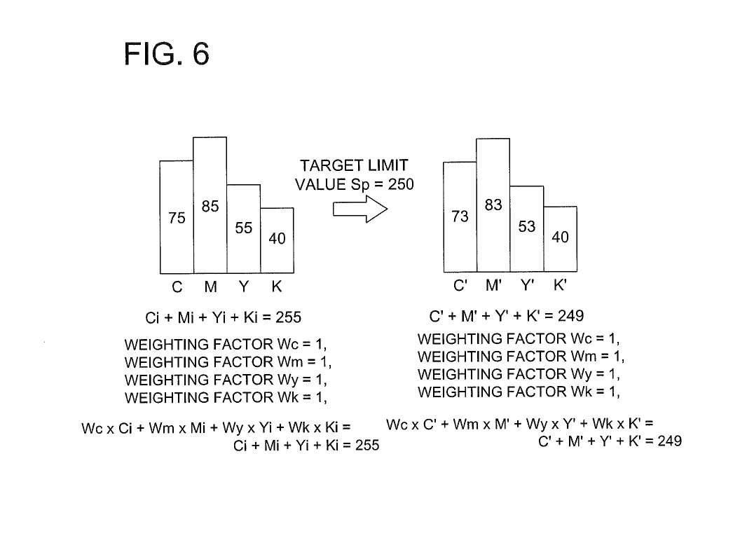

FIG. 6 shows an example where, after the color material amount limitation of application example 1 is executed as shown in FIG. 5, the color material amount limitation of application example 3 is executed. The color material amounts of input values are the values after the execution of color material amount limitation of FIG. 5, which are: Ci=75, Mi=85, Yi=55, and Ki=40. Further, weighting factor Wc=1, weighting factor Wm=1, weighting factor Wy=1, weighting factor Wk=1. In this case the color material amount summation S becomes Ci+Mi+Yi+Ki=255. Since the target limit value Sp is 250, required reduction amount D becomes 5. For example, in the case of reducing the color material amount by abovementioned calculation example 2 which equally reduces the amounts, since required reducing amount form C+M+Y is 5, each color material of C, M, Y is reduced by 2, for example. The results become: C′=73, M′=83, Y′=53, and K′=K=40.

### APPLICATION EXAMPLE 4

In the system (for example, image forming section 14) where the order of possibility for causing the toner scattering is color material Y>color material M>color material C>color material K, by setting weighting factor Wc=0.8, weighting factor Wm=0.9, weighting factor Wy=1, weighting factor Wk=0.7, the limit table is created such that the upper limit of color material amount summation S becomes 250%. Then, based on this limit table, increasing/decreasing adjustment of the color material amount (color material amount calculation) is executed. In the color material amount calculation, the increase/decrease rate is set such that −ΔC:−ΔM:−ΔY:ΔK=p:q:r:s, (respective values are calculated from predetermined parameters or C, M, Y, K), and by the increasing or decreasing, color material amount summation S is controlled to coincide with target limit value Sp. In this regard, lower limit of color material amount of C, M, Y is restricted to 0%, and upper limit of color material amount of K is restricted to 100%.

According to application example 4, problems such as the toner scattering is similar to the case where the limit table is created such that color material amount summation becomes 250% without considering the weighting factor as conventionally, and the amount of color material with fewer effect to toner scattering can be increased to a certain extent, which results in improving the reproducibility in shadow area of the image to improve the image quality.

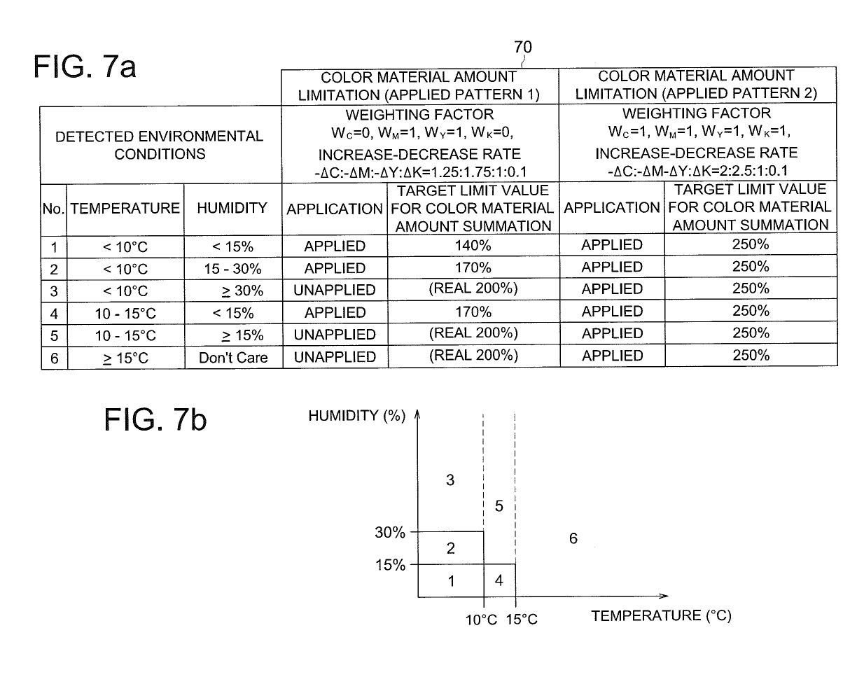

FIG. 7a shows an example of condition control table 70 stored in weighting factor setting section 31. Condition control table 70 is the table where various parameters to be used in the case of executing the color material amount limitation are previously registered, by each application pattern, and by ambient temperature and humidity. In this example, application pattern 1 corresponds to the abovementioned application example 1 and application pattern 2 corresponds to the abovementioned application example 3. In condition control table 70, registered are weighting factors and increase-decrease rates (p:q:r:s) by each application pattern. In this example, ambient temperature and humidity is sectionalized to 1-6 regions, with respect to each application pattern, applying or not-applying the color material amount limitation by each ambient temperature and humidity segment region, and the target limit value (target limit value for color material amount summation) in saturation region 63 are registered. FIG. 6b shows the segment regions 1-6 of ambient temperature and humidity.

Based on this condition control table 70, weighting factor setting section 31 selects parameters corresponding to the ambient temperature and humidity at the time of printing, and sets these parameters in color material amount control section 32. Color material amount control section 32 executes the color material amount limitation according to the parameters having been set. For example, if the segment region of ambient temperature and humidity detected by temperature/humidity sensor 24 is 1, weighting factor setting section 31 creates a limit table to make the target limit value for color material amount summation to be 140%, and set this table, weighting factor and increase-decrease rate of application pattern 1 into color material amount control section 32. Color material amount control section 32 executes the color material amount limitation process with these conditions having been set.

After that, successively, weighting factor setting section 31 creates a limit table to make the target limit value for color material amount summation to be 250%, and set this table, weighting factor and increase-decrease rate of application pattern 2 into color material amount control section 32. Color material amount control section 32 executes the color material amount limitation process with these conditions having been set. The temperature sensor and humidity sensor may be configured to be provided in image forming apparatus 10, and the configuration where image forming apparatus 10 obtains detected values from externally provided temperature sensor and humidity sensor is also applicable.

Further, in the case where the ambient temperature and humidity are in segment region 3, weighting factor setting section 31 controls not to execute the color material amount limitation by application pattern 1, but only to execute the color material amount limitation by application pattern 2. Namely, weighting factor setting section 31 creates a limit table to make the target limit value for color material amount summation to be 250%, and set this table, weighting factor and increase-decrease rate of application pattern 2 into color material amount control section 32. Color material amount control section 32 executes the color material amount limitation process with these conditions having been set.

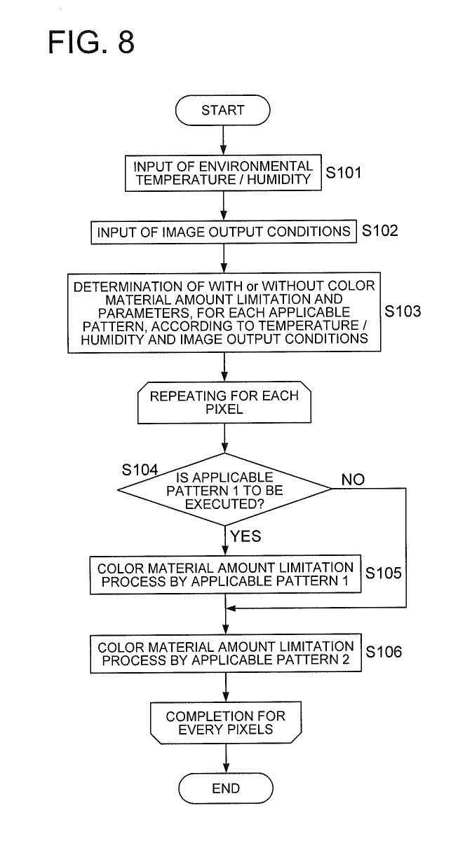

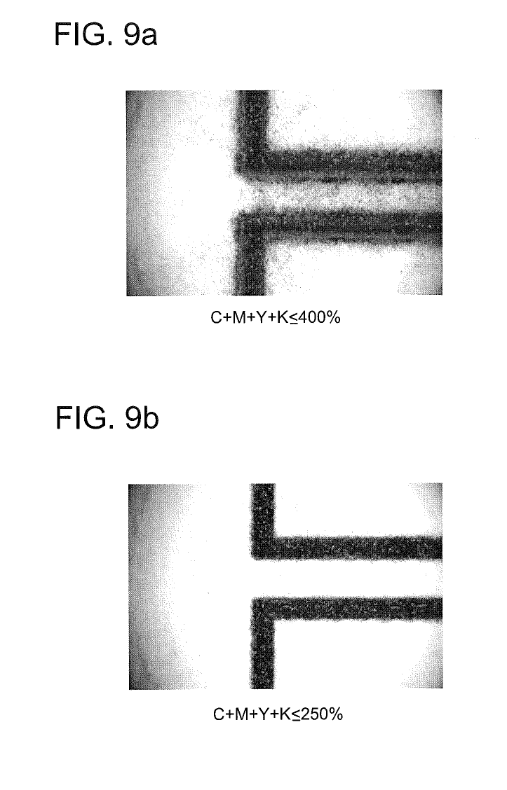

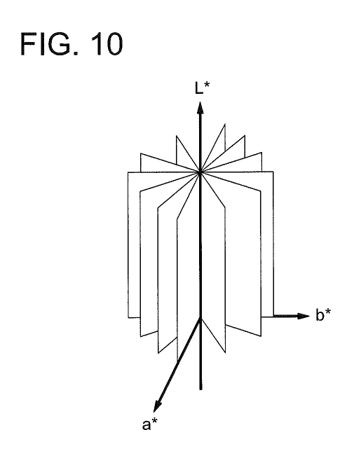

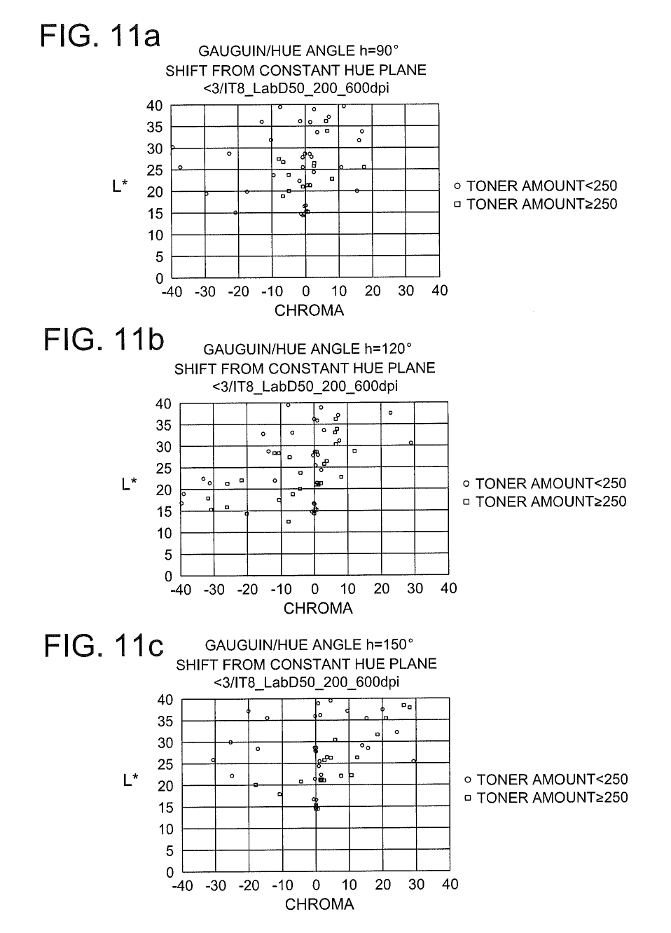

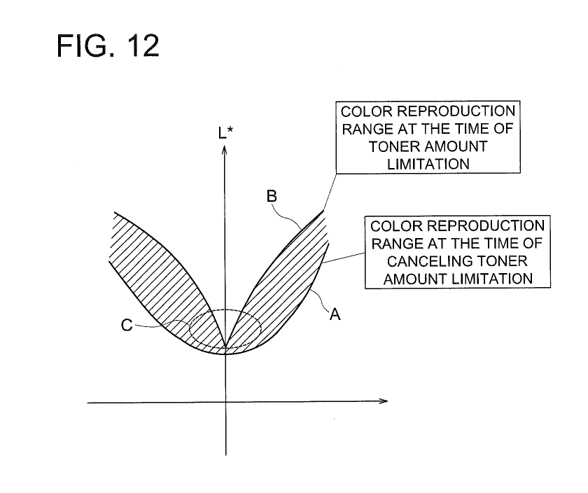

FIG. 8 shows the flow of color material amount limitation operation by weighting factor setting section 31 and color material amount control section 32. Firstly, obtaining the ambient temperature and humidity (step S101), and further obtains image output conditions (step S102). For example, CPU 11 of image forming apparatus 10 obtains the ambient temperature and humidity from temperature/humidity sensor provided in the apparatus itself. Further obtains the type of recording sheet through a sensor or user setting on operation section 19. Further, CPU 11 recognizes the condition whether second side print of both sides printing or not, and the like from job setting conditions or progress status of the job.

From these ambient temperature and humidity and image output conditions, CPU 11 (weighting factor setting section 31) determines the color material amount limitation of which application pattern is to be executed, and parameters (weighting factor, increase-decrease rate, target limit value summation) to be used for each color material amount limitation (step S103). Here, there are a case to execute application pattern 1 and application pattern 2, and a case to executes only application pattern 2, and the flag indicating to execute application pattern 1 or not is set at step S103.

Next, CPU 11 (color material amount control section 32) executes the process described below by each pixel of the subject image for processing. CPU 11 checks if the setting to execute the color material amount limitation by application pattern 1 has been established or not (the aforementioned flag has been set or not) in step S104. In the case to execute (step S104; Yes), executes the color material amount limitation process by application pattern 1 (step S105), and after that, further executes the color material amount limitation process by application pattern 2 (step S106).

In the case where the setting to execute the color material amount limitation by application pattern 1 is not established (step S104; No), executes the color material amount limitation process by application pattern 2 (step S106).

According to the color material amount limitation method of the present invention, even if possibility of generating harmful effects, such as the toner scattering caused by excessive color material amount, differs due to various factors, such as properties of each color material and printing order of color material in the image forming section, the method determines overabundance of the color material amount by multiplying the weighting factor corresponding to the possibility of harmful effects, and can limit the color material amount according to the properties of color material or image forming section. Therefore, it is capable to properly suppress the harmful effects caused by the excessive amount of the color material without limiting the color material amount more than necessary (namely with small effect to color reproducibility).

Specifically, by respectively applying the color material amount limitation for the color (secondary color) being expressed by combination of two colors such as M+Y, and for the color material amount limitation for the summation of all color materials amount, the harmful effects of overabundant color material amount for both cases can be prevented. Further, by executing the color material amount limitation process utilizing different weighting factors, sequentially for several times, the limiting amount by each color material amount limitation can be made small, thus the harmful effects of excessive color material amount can be prevented with less restriction to color reproducibility.

As described above, the embodiment of present invention is explained referring to the drawings, however, the specific configuration should not be restricted to the embodiment, but changes or additions are construed to be included without departing from the scope of the invention.

For example, although the case of using the color material of C, M, Y, K is explained in the embodiment, colors of the color material or number of colors is not restricted to this.

Further, although in the embodiment, red color (M+Y) is exemplified as the secondary color being expressed by combination of two colors among C, M, and Y, secondary colors such as C+M, and C+Y are also applicable. In the case of C+M, weighting factors may be set as: weighting factor Wc=1, weighting factor Wm=1, weighting factor Wy=0, weighting factor Wk=0, and in the case of C+Y, weighting factors may be set as: weighting factor Wc=1, weighting factor Wm=0, weighting factor Wy=1, weighting factor Wk=0.

Further, the color material amount limitation may be executed for each of the plurality of secondary colors. For example, by setting waiting factors, a limit table, and increase-decrease rates, with respect to each of four colors of M+Y, C+M, C+Y, and C+M+Y+K, color material amount limitations for these four colors may be sequentially executed.

Further, what type of application pattern is to be used for the color material amount limitation may be controlled by each pixel. For example, by determining a color of the pixel, if the color is a specific color, the color material amount limitation corresponding to the specific color may be executed. For example, the control may be such that: if the pixel is red color, the color material amount limitation process for M+Y is executed for the pixel, and if not red color, the color material amount limitation process for M+Y is not executed.

Further, although image forming apparatus 10 is exemplified in the embodiment, the color material amount limitation process may be configured to be performed by an image processing apparatus (such as a print controller) not having the image forming section. In this case, various conditions relating to the color material amount limitation process such as properties regarding the color material amount limitation (weighting factor, limit table, etc.) of the printer to be used, image output conditions, ambient temperature and humidity information are previously inputted and set in the image processing apparatus. And, by inputting image data of print subject in the image processing apparatus, the apparatus is allowed to execute the color material amount limitation process, and to output the processed image data to the printer.

What is claimed is:

1. A color material amount control method comprising:
setting a weighting factor of each color material to be used for image formation; and
for each pixel, obtaining a color material amount summation by product sum of color material amount and the weighting factor of each color material, obtaining a required reduction amount for the color material amount summation from a predetermined target limit value with respect to the color material amount summation, and correcting the color material amount for each color material so as to reduce the required reduction amount from the color material amount summation.

2. The color material amount control method of claim 1, wherein the weighting factor is set according to a prescribed value predetermined based on characteristics of an image forming apparatus to form an image using the color material, or the weighting factor is set according to image output conditions.

3. The color material amount control method of claim 1, wherein the weighting factor is set according to a color of the pixel.

4. The color material amount control method of claim 1, wherein the step of correcting the color material amount is executed sequentially in plural times by using different weighting factors.

5. An image forming apparatus comprising:
an image forming section to form an image with a plurality of color materials;
a setting section to set a weighting factor for each color material; and
a color material amount control section which, for each pixel, obtains a color material amount summation by product sum of color material amount and the weighting factor of each color material, obtains a required reduction amount for the color material amount summation from a predetermined target limit value with respect to the color material amount summation, and corrects the color material amount for each color material so as to reduce the required reduction amount from the color material amount summation,
wherein the image forming section forms the image according to the color material amount of each color material after corrected by the color material amount control section.

6. The image forming apparatus of claim 5, wherein the setting section sets the weighting factor predetermined according to characteristics of the image forming section, or sets the weighting factor according to image output conditions.

7. The image forming apparatus of claim 5, wherein the setting section sets the weighting factor according to a color of the pixel.

8. The image forming apparatus of claim 5, wherein the color material amount control section corrects the color material amount sequentially in plural times by using different weighting factors.
